(19) United States
(12) Patent Application Publication
(10) Pub. No.: US 2007/0095293 A1
(43) Pub. Date: May 3, 2007

(54) Treat dispensing device and a method thereof

(76) Inventor: Reynolds Ellswoth Moulton, Brooklyn, NY (US)

Correspondence Address: DOGMATIC PRODUCTS, INC., 158 SUMMIT STREET, BROOKLYN, NY, 11231, US

(21) Appl. No.: 11/264,225

(22) Filed: Oct. 31, 2005

(51) Int. Cl. A01K 5/00

(52) U.S. Cl. 119/51.01

(57) ABSTRACT

In one embodiment, a treat dispensing device is provided. Accordingly, the device comprises a housing having a handle part and a dispensing part. The handle part comprises a trigger member configured for gripping by the user. The dispensing part comprises an aperture configured at a proximal end and a pushing member coupled to an energizing member configured at a distal end. A chamber for loading an individual or a plurality of solid shaped treats is configured in-between the aperture and the pushing member. The trigger member is co-ordinatingly coupled to the pushing member. When the trigger member is pressed by the user, the pushing member retreats and pushes out at least one treat through the aperture to a location at a distance predetermined from the housing.

### CROSS REFERENCE TO RELATED APPLICATIONS

Not Applicable

### TECHNICAL FIELD

This invention relates generally to dispensing devices, and more particularly to, a device and method for interactively dispensing treats to pets.

### BACKGROUND

Various types of treat dispensing devices that can dispense various forms and shapes of treat are available in the market for feeding pets. Some examples include treat dispensing devices that adopt timing mechanism for supplying treats to pets at predetermined intervals. Some treat dispensing devices adopt toy shaped configurations in addition to treat dispensing mechanisms to attract pets and also keep them active during feeding. These treat dispensing devices are either permanently installed or configured portable for easy handling.

U.S. Pat. No. 6,026,985 entitled “Food Dispenser Gun” by Elliott, Sr, issued Feb. 22, 2000 discloses a trigger gun mechanism to dispense incremental quantities of extrudable food products such as, pureed food in a food industry.

However, none of the above dispensing devices provide for (i) an interactive method of dispensing treat; (ii) easy handling and dispensing by user so as to have enhanced fun activity and training to pet, and (iii) handling treats in various solid shapes.

### SUMMARY OF THE INVENTION

The above-mentioned shortcomings, disadvantages and problems are addressed herein, which will be understood by reading and studying the following specification.

In one embodiment, a treat dispensing device is provided. Accordingly, the device comprises a housing having a handle part and a dispensing part. The handle part comprises a trigger member configured for gripping by the user. The dispensing part comprises an aperture configured at a proximal end and a pushing member coupled to an energizing member configured at a distal end. A chamber for loading a plurality of solid shaped treats is configured in-between the aperture and the pushing member. The trigger member is co-ordinatingly coupled to the pushing member. When the trigger member is pressed by the user, the pushing member retreats and pushes out at least one treat through the aperture to a location at a distance predetermined from the housing.

In another embodiment, a treat dispensing device is provided. Accordingly, the device comprises a hand-held housing, a means for loading a plurality of treats into the housing, and a means for dispensing provided within the housing and configured to dispense at least one treat at a time to a location at a predetermined distance away from the housing.

In a further embodiment a treat dispensing method for pets is provided. Accordingly, the method comprises configuring a hand-held means operable by a user, wherein said means is configured for storing and dispensing treats. When the user activates dispensing operation, the treats are launched one by one to a location at a distance from the hand-held means, wherein the pet chases the dispensed treat.

### BRIEF DESCRIPTION OF THE DRAWINGS

FIG. 1 shows a partial cross-section of a treat dispensing device according to a preferred embodiment of the present invention.

### DETAILED DESCRIPTION OF THE PREFERRED EMBODIMENT

In the following detailed description, reference is made to the accompanying drawings that form a part hereof, and in which is shown by way of illustration specific embodiments which may be practiced. These embodiments are described in sufficient detail to enable those skilled in the art to practice the embodiments, ands it is to be understood that logical, mechanical, and other changes may be made without departing from the scope of the embodiments. The following detailed description is, therefore, not to be taken in a limiting sense.

Various embodiments of this invention provide a treat dispensing device and a method of interactively dispensing treats to pets such as, for example dogs and cats. However, the embodiments are not limited, and may be implemented in connection with dispensing solid medicinal substances also to human beings.

A treat dispensing method for pets according to one embodiment of this invention comprises configuring a hand-held means operable by a user, wherein said means is configured for storing and dispensing treats. When the user activates dispensing operation, the treats are launched to a location at a distance predetermined from the hand-held means, wherein the pet chases the dispensed treat.

For example, the hand-held means may include a launching gun configured for gripping by user for dispensing operation.

A treat dispensing device according to one embodiment of this invention comprises a hand-held housing, a means for loading a plurality of treats into the housing, and a means for dispensing provided within the housing and configured to dispense at least one treat at a time to a location at a predetermined distance away from the housing.

In some embodiment, the means for dispensing comprises a launching gun mechanism. The launching gun comprises a trigger means for activating the dispensing operation of the treat. The means for loading includes a chamber in the housing configured for accommodating a stack of treats. The treats are launched to a location at a distance from the housing so as to enable a pet to chase the launched treat.

It should be noted that launching the treats to a location at a distance using a launching mechanism and thereby enabling the pet to chase the launched treat increases the fin activity and interaction between the pet and the pet owner or user. Increased fun activity enhances health and training exercise to the pets.

In one embodiment, the treat comprises an edible material. In one example, the treat is composed of processed wheat gluten, hydrolyzed protein, glycerin, natural flavor, monosodium phosphate and magnesium stearate.

In another embodiment, the treat further comprises at least one of a medicinal ingredient. In further embodiments, the treat further comprises a health enhancing ingredient. In some embodiments, the treats have a rigid solid shape such as, for example a ball shape or a disc shape. This shape facilitates launching at a flying mode so that the pet is interested in chasing the launched treat.

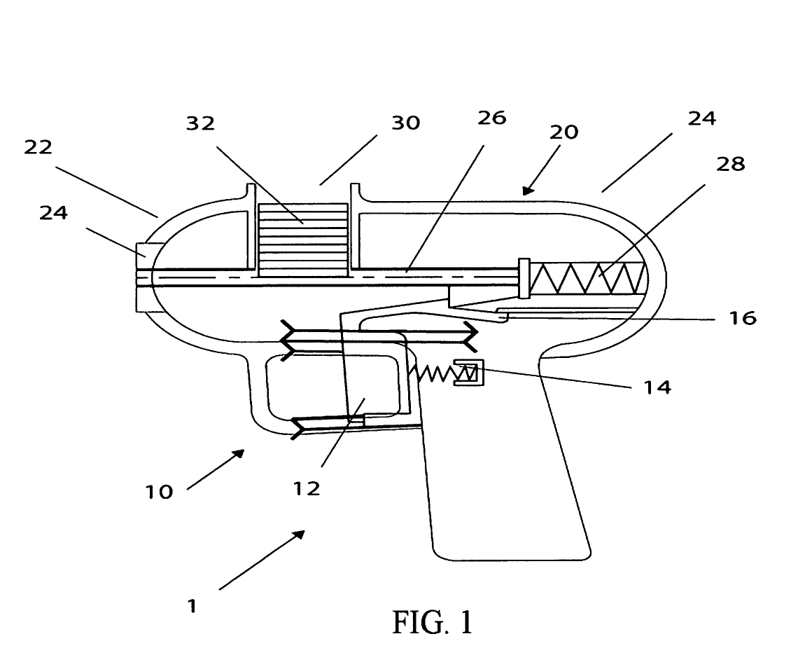

FIG. 1 shows a partial cross-section of a treat dispensing device according to the preferred embodiment of this invention. Accordingly, the device comprises a housing 1 having a handle part 10 and a dispensing part 20. The handle part 10 comprises a trigger member 12 and is configured for gripping by the user. The dispensing part 20 comprises an aperture 34 configured at a proximal end 22 and a pushing member 26 coupled to an energizing member, e.g. a spring 28 configured at a distal end 24. A chamber 30 for loading an individual or a plurality of solid shaped treats 32 is configured in-between the aperture 24 and the pushing member 26.

The trigger member 12 is co-ordinatingly coupled to the pushing member 26 as shown in FIG. 1. In normal circumstances, the pushing member 26 can be configured to be in retreated position by applying pressure to the energizing member 28. When the trigger member 12 is pressed by the user, the pushing member 24 advances due to release of tension built up in the energizing member 28 and pushes out (launches) at least one treat through the aperture 34 to a location at a distance from the housing 1.

In an example, the trigger member 12 is energized by a first spring 14. For the next dispensing operation, the pushing member 26 is again brought to retracted position by applying pressure to the second spring 28. This can be achieved by manually depressing the trigger member 12. By depressing the trigger member 12, lever 16 moves back until it releases the tension from the second spring 28. A spring guard 18 pushes against the second spring 28 from the pressure places on the trigger member 12. The tension, once released from the second spring 28 is then transferred to the treat 32 which moves through the chamber 26, exiting through the aperture 34.

It should be noted that launching the treats 32 to a location at a distance using a launching mechanism and thereby enabling the pet to chase the launched pet increases the fun activity and interaction between the pet and the pet owner or user. Increased fun activity enhances health and training exercise to the pets.

In one embodiment, the treat comprises an edible material. In one example, the treat is composed of processed wheat gluten, hydrolyzed protein, glycerin, natural flavor, monosodium phosphate and magnesium stearate.

In another embodiment, the treat further comprises at least one of a medicinal ingredient. In further embodiments, the treat further comprises some health enhancing ingredient.

In some embodiments, the treats 32 have a rigid solid shape such as, for example a ball shape or a disc shape. This shape facilitates launching at a flying mode so that the pet is interested in chasing the launched treat.

Thus, various embodiments of the present invention provide a method for dispensing treats to pets. Further embodiments of this invention provide a treat dispensing device.

It will be obvious for a person of skilled in the art to practice the invention with modifications. However, all those modifications will be deemed to be covered within the scope of the invention as covered in the claims hereunder.

What is claimed is:

1. A treat dispensing device, comprising:
(i) a housing;
(ii) a dispensing part within the housing;
(iii) the dispensing part comprising;
(a) at least one proximal end and at least one distal end;
(b) an aperture configured at the proximal end;
(c) a pushing member coupled to an energizing member configured at the distal end; and
(d) a chamber for loading a plurality of solid shaped treats, configured in-between the aperture and the pushing member;
(iv) wherein a trigger member is co-ordinatingly coupled to the pushing member, wherein when the trigger member is operated by a user, the pushing member is configured to push out at least one treat through the aperture to a location at a distance from the housing.

2. A treat dispensing device according to claim 1 further comprising a handle part wherein the trigger member is configured within the handle part.

3. A treat dispensing device according to claim 2 wherein the handle part is configured to be gripped by user for operating the trigger member.

4. A treat dispensing device according to claim 1 wherein the distance is predetermined to enable a pet to chase the dispensed treat.

5. A treat dispensing device according to claim 2 wherein the treat comprises an edible material.

6. A treat dispensing device according to claim 5 wherein the treat comprises one or more among processed wheat gluten, hydrolyzed protein, glycerin, natural flavor, monosodium phosphate and magnesium stearate.

7. A treat dispensing device according to claim 5 wherein the treat further comprises a medicinal ingredient.

8. A treat dispensing device according to claim 5 wherein the treat further comprises a health enhancing ingredient.

9. A treat dispensing device according to claim 1 wherein the treat comprises at least one of a disc shape and a ball shape.

10. A treat dispensing device comprising;
(i) a hand-held housing;
(ii) a means for loading an individual or a plurality of treats into the housing; and
(iii) a means for dispensing provided within the housing and configured to dispense at least one treat at a time to a location at a predetermined distance away from the housing.

11. A treat dispensing device according to claim 10 wherein the means for dispensing comprises a launching gun mechanism.

12. A treat dispensing device according to claim 11 wherein the launching gun comprises a trigger means for activating the dispensing operation.

13. A treat dispensing device according to claim 10 wherein the distance is predetermined so as to enable a pet to chase the launched treat.

14. A treat dispensing device according to claim 10 wherein the means for loading includes a chamber configured for accommodating a stack of treats.

15. A treat dispensing device according to claim 10 wherein the treat comprises an edible material.

16. A treat dispensing device according to claim 15 wherein the treat comprises processed wheat gluten, hydrolyzed protein, glycerin, natural flavor, monosodium phosphate and magnesium stearate.

17. A treat dispensing device according to claim 15 wherein the treat further comprises at least one of a medicinal ingredient and a health enhancing ingredient.

18. A treat dispensing device according to claim 17 wherein the solid shape comprises at least a ball shape or a disc shape.

19. A treat dispensing method for pets comprising:
(i) configuring a hand-held means operable by user, wherein said means is configured for storing and dispensing treats;
(ii) activating the dispensing operation wherein the treats are launched to a location at a distance predetermined from the hand-held means, wherein the pet chases the treat following launching.

20. A treat dispensing method according to claim 19 wherein the hand-held means comprises a launching gun.
